(19) United States
(12) Patent Application Publication
(10) Pub. No.: US 2013/0013089 A1
(43) Pub. Date: Jan. 10, 2013

(54) STAGE PRODUCTION SYSTEM, SUBSYSTEM FOR CONTROLLING PRODUCTION, OPERATION METHOD AND PROGRAM THEREOF

(75) Inventors: Nobuo KAWAKAMI, Tokyo (JP); Yasuyuki SUGITANI, Tokyo (JP); Taichi SHIDARA, Tokyo (JP); Shinnosuke IWAKI, Tokyo (JP)

(73) Assignee: DWANGO CO., LTD., Tokyo (JP)

(21) Appl. No.: 13/543,264

(22) Filed: Jul. 6, 2012

(30) Foreign Application Priority Data
Jul. 8, 2011 (JP) 2011-152319
Apr. 9, 2012 (JP) 2012-088760

(51) Int. Cl. G06F 19/00

(52) U.S. Cl. 700/90

(57) ABSTRACT

Conventionally, a system for real-time distribution of images of the various productions of the stage to user terminals on the network has been provided. However, it is nothing but an image, the viewer can hardly feel for participation in the performance including the production. In order to solve the above deficiency, the present invention provides a stage production system, which receives an entry of a comment for distributed live image of the stage from the user terminal on the network, promptly displays the comment in a viewable state for a viewer of the distribute live image on a display, and controls the production equipment on the real stage such as the lighting equipment, sound equipment, and smoke machine.

### BACKGROUND OF THE INVENTION

1. Field of the Invention

The present invention relates to a technology for controlling stage production in response to comment entry from a user terminal the stage via network.

2. Description of the Related Art

Conventionally, lighting equipment, sound equipment, and a smoke machine etc. are installed on a stage for a performance and event, and a manager remotely controls such equipment from a predetermined booth, thereby performing the stage production. Moreover, a stage production technology, where a display is placed on the stage, and the so-called VJ (Video Jockey) freely controls the display with his creativity in response to a performance etc. on the stage, has been provided.

Moreover, in Japanese Unexamined Patent Application Publication No. 2005-285049, a production technology, where a video message for a wedding ceremony etc. is received from a user terminal connected through the network, and the message is displayed on a display in the hall in the middle of the ceremony, thereby warming up the ceremony, is disclosed.

Additionally, a system, where images of the various productions of the stage are taken, and real-time distribution of such images to unspecified number of terminals on the network is possible utilizing simple equipment and techniques on the individual level, has been provided. Therefore, even if a user does not go to the stage, it is possible to view the image distributed in real time through the network utilizing the user terminal, and to enjoy the performance with various stage productions in real time.

### RELATED ART DOCUMENTS

Patent Document 1: Japanese Unexamined Patent Application Publication No. 2005-285049

In the above conventional system, although it is nothing but an image, the viewer can hardly feel the reality in the performance with the production, and compared with an audience who actually watches the stage, the viewer gets less feeling of participation in the performance on the stage.

### SUMMARY OF THE INVENTION

In order to solve the above deficiencies, we provide a stage production system, which receives an entry of a comment for distributed live image of the stage from the user terminal on the network, promptly displays the comment in a viewable state for a viewer of the distribute live image on a display, and controls the production equipment on the real stage such as the lighting equipment, sound equipment, and smoke machine.

Specifically, the stage production system, comprises a subsystem for controlling production, controlling stage production; a user terminal, being connected with the subsystem for controlling production through network; and a display, displaying a comment entered through the user terminal, wherein the subsystem for controlling production further comprises a production equipment, producing stage, a distribution unit, distributing a live image of the stage to the user terminal, a rule storage, storing a rule for control of production on the basis of the comment, a comment receiver, receiving the comment transmitted from the user terminal, and a production controller, controlling the production equipment for the live stage on the basis of the received comment and the stored rule for control of production.

Moreover, the user terminal comprises a live image receiver, receiving the distributed live image, a live image display unit, displaying the received live image, a comment entry reception unit, receiving an entry of a comment for the displayed live image, and a comment transmitter, promptly transmitting the received comment, and the display comprises a comment acquisition unit, acquiring the entered comment through the user terminal, and a comment display unit, displaying the acquired comment in a viewable state for a user of the user terminal.

According to this, the viewer of the stage can view the distributed live image of the stage including display of the comment entered by the viewer utilizing the user terminal, and can control the production equipment on the stage by the comment, so that the viewer can get a feel for participation in the performance on the real stage in a different way from the viewer of the real stage.

Moreover, we provide a stage production system, wherein the display is placed in a hall with the stage. Moreover, we provide a stage production system, wherein the production controller of the subsystem for controlling production comprises a stage display control section, controlling the display as the production equipment in the hall with the stage. Moreover, we provide a stage production system, wherein the production controller of the subsystem for controlling production comprises a control section for production device of viewer, controlling a production device distributed to a viewer in the hall with the stage as the production equipment.

Moreover, we provide a stage production system, wherein the stage display control section comprises an avatar control device, controlling an action of an avatar to be displayed on the display placed on the stage. Moreover, we provide a stage production system, wherein the production controller comprises a reception section for initiating action, initiating the action of the avatar to be displayed on the display placed on the stage.

Moreover, we provide a stage production system, wherein the comment transmitter of the user terminal further comprises a transmission section for comment with ID, transmitting the comment correlated with a user ID and/or a terminal ID, and wherein the subsystem for controlling production further comprises an avatar display unit, displaying an avatar on the display in the hall with stage on a basis of the ID, the rule storage further comprises an avatar rule storage section, storing a rule for control of production for the avatar, and the stage display control section further comprises an avatar production device, producing the avatar displayed on the display on the basis of the received comment and ID, and on the stored rule for control of production for avatar.

Furthermore, we provide a method for operating the above stage production system and the subsystem for controlling production for controlling production, and a program thereof.

According to the present invention having the above configuration, even the viewer (viewer of a virtual world) of the stage can view the distributed live image of the stage including the comment entered by the viewer utilizing the user terminal, and can control the production equipment on the stage by the comment, so that the viewer can get a feel for participation in the performance on the real stage in a different way from the viewer (viewer of the real world) of the real stage.

### BRIEF DESCRIPTION OF THE DRAWINGS

FIG. 1 is a conceptual diagram of exemplifying a stage production control by a stage production system of a first embodiment.

FIG. 2 is a functional block diagram of the stage production system of the first embodiment.

FIG. 3 is a diagram exemplifying a rule for control of production stored in a rule storage of a subsystem for controlling production of the first embodiment.

FIG. 4 is a diagram exemplifying comment entry in a comment entry reception unit of a user terminal of the first embodiment.

FIG. 5 is a diagram showing an example of comments according to an installation site for a display of the first embodiment.

FIG. 6 is a diagram showing another example of comments according to an installation site for a display of the first embodiment.

FIG. 7 is a diagram exemplifying a hardware configuration of the subsystem for controlling production of the first embodiment.

FIG. 8 is a diagram exemplifying a hardware configuration of the user terminal of the first embodiment.

FIG. 9 is a diagram exemplifying a hardware configuration of a display of the first embodiment.

FIG. 10 is a flowchart of the stage production system of the first embodiment.

FIG. 11 is a conceptual diagram showing another example of the stage production control by the stage production system of the first embodiment.

FIG. 12 is a conceptual diagram showing an example of the stage production control (avatar display) by the stage production system of a second embodiment.

FIG. 13 is a functional block diagram of the stage production system of the second embodiment.

FIG. 14 is a flowchart of the stage production system of the second embodiment.

FIG. 15 is a functional block diagram of the stage production system of a third embodiment.

FIG. 16 is a conceptual diagram exemplifying an action control of an avatar by the stage production system of the third embodiment.

FIG. 17 is a flowchart of the stage production system of the third embodiment.

### DESCRIPTION OF THE PREFERRED EMBODIMENTS

Hereinafter, embodiments of the present invention will be described with reference to diagrams. The present invention is not to be limited to the above embodiments and able to be embodied in various forms without departing from the scope thereof.

Embodiments of the present invention will be described hereinafter. Relationships between the embodiments and claims are as follows. The first embodiment will mainly describe Claims 1, 2, 3, 7, 8, 9, 10, 11 and 12. The second embodiment will mainly describe Claims 3 and 6. The third embodiment will mainly describe Claims 4 and 5.

### First Embodiment

### Outline of First Embodiment

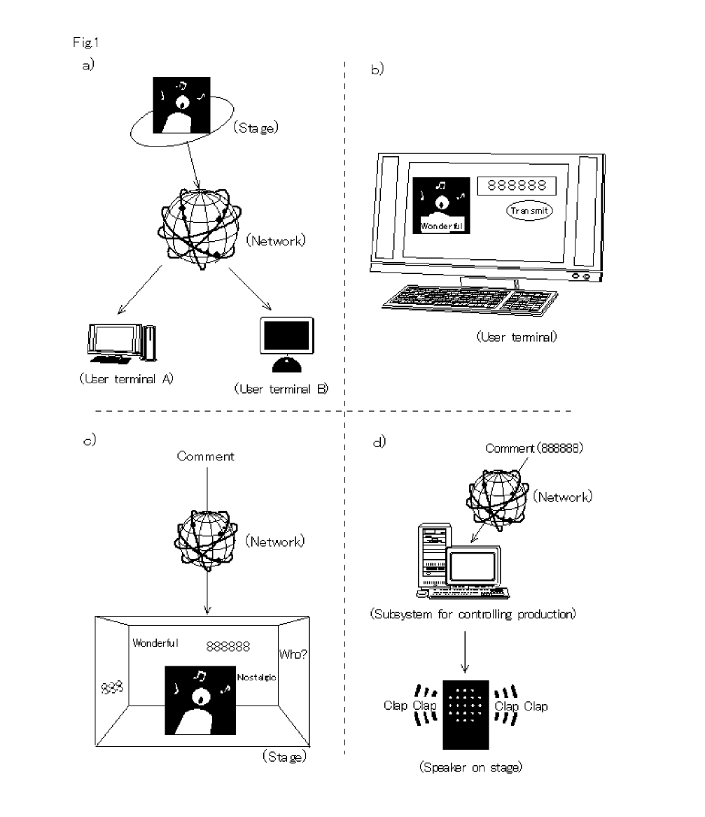

FIG. 1 is a conceptual diagram of exemplifying a stage production control by a stage production system of a first embodiment. As shown in FIG. 1(a), the live image of the stage for an event or a performance is distributed to the user terminal through the network. Moreover, as shown in FIG. 1(b), the viewer using the user terminal (hereinafter, referred to as a virtual viewer) watches the live image of the stage, freely posts a comment, for example, ‘8888888 (expressing claps)’ in an entry space, and clicks a transmission button.

Subsequently, as show in FIG. 1(c), the posted comment (including a comment posted through another user terminal) is acquired by a large display installed on the backside, both sides of the stage or behind the spectator's seats, and is displayed on the display in a circular manner. Simultaneously, as shown in FIG. 1(d), a subsystem for controlling production installed near the stage receives the comment (‘888888’), and controls, such that the ‘sound of claps’ is outputted as production from the sound equipment installed, for example, on the stage or ceiling. Therefore, the virtual viewer can enjoy display of the comment, entered by the viewer, on the display of the stage, and the sound of claps from the sound equipment in response to the comment through the distributed live image.

Thus, even the virtual viewer, who does not actually watch the stage, can display the comment posted by the viewer, and can control the production equipment on the stage by the comment, so that the viewer can get a feel for participation in the performance on the real stage in a different way from the viewer (hereinafter, referred to as real viewer) of the real stage.

Moreover, the real viewer can enjoy the production such as the sound output of claps on the stage, thereby enhancing the togetherness between the virtual viewer and the real viewer.

<Functional Configuration of First Embodiment>

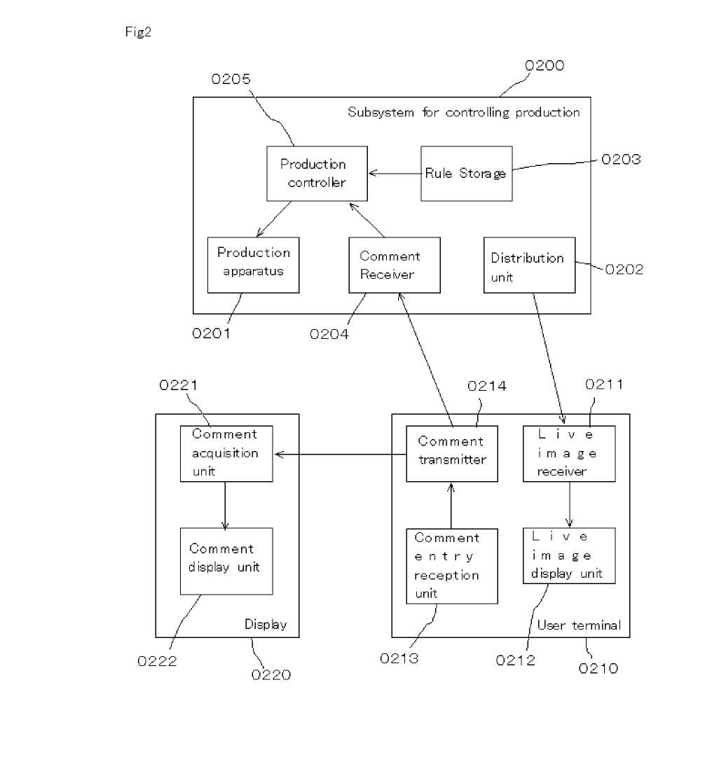

FIG. 2 is a functional block diagram of the stage production system of the first embodiment. As shown in FIG. 2, a stage production system of the first embodiment comprises a ‘subsystem for controlling production’ (0200), a ‘user terminal’ (0210), and a ‘display’ (0220).

Note that, the following functional block of the respective subsystem for controlling productions and apparatuses of the system can be implemented by combination of hardware and software. Specifically, in the case of utilizing a computer, examples of the hardware and software include hardware components configured by a CPU, a main memory, a bus, a secondary storage device (e.g., a hard disk or a nonvolatile memory, a storage media such as CD-ROM or DVD-ROM, or a reading drive for the above media), an input device for inputting information, a printing device, a display device, other peripheral devices; and interfaces for the other peripheral devices and a communication interface; and driver program for controlling the above hardware, other application programs, and an application for user interface. The CPU executes an operation in accordance with the program developed on the main memory, so that processing and storing of the data, inputted through the input device or the interface etc. and stored in the memory of the hard disk, are executed, and instructions to control the hardware and software are generated. Moreover, the functional block of the system may be implemented by a specialized hardware.

Moreover, the present invention can be implemented not only as a system but also as a method thereof. Moreover, a portion of such inventions may be configured as software. Furthermore, a software product used for causing a computer to execute such software, and the recording medium, in which the software is installed, should be included in the technical scope of the present invention (the same applies throughout the entire specification).

(Subsystem for Controlling Production)

At the outset, descriptions of components of the subsystem for controlling production are provided. The subsystem for controlling production is a subsystem configured by a server for image distribution and the control of production of the stage, and a terminal, or an integrated apparatus of a combination thereof. As shown in FIG. 2, the subsystem comprises a ‘production equipment’ (0201), a ‘distribution unit’ (0202), a ‘rule storage’ (0203), a ‘comment receiver’ (0204), and a ‘production controller’ (0205).

The ‘production equipment’ (0201) is for producing stage, and various production method may be utilized. Examples of the lighting equipment include various lights, laser equipment, a mirror ball, and light-shielding equipment, and examples of the sound equipment include various speakers. Additionally, examples of other equipment include a smoke machine for smoke effects, an explosion device for safety effect, a firing device such as a torch, a watering device, a temperature conditioner, and floor vibration equipment for producing sensory effect.

Moreover, a display for displaying an image placed in the hall with a stage is an example of the production equipment for effect by the image display. The display may be configured as the after-mentioned display for comments entered from the user terminal.

Moreover, the ‘stage’ is a space for a performance or an event, and is not limited to a space definitely partitioned off other spaces and may be an outdoor stage. The ‘stage production’ is not limited to production of a space for the performance etc, and may be production for a hall including the stage (e.g., a space including spectator's seats etc.), which the real viewer can perceive the production.

The ‘distribution unit’ (0202) has a function of distributing a live image of the stage to the user terminal, and can be implemented, for example, by a CPU, a main memory, a communication circuit, and a distribution program for live image. The distribution of live image is distributing the performance etc. on the stage in nearly real time, and an example thereof includes streaming the image.

Therefore, the comment for the distributed live image of the stage is entered utilizing the after-mentioned user terminal, and is promptly reflected on the distributed image, and the production controlled according to the comment is included in the distributed image, so that the virtual viewer can get a feel for participation in the performance on the real stage and a sense of unity.

The ‘rule storage’ (0203) has a function of storing a rule for control of production on the basis of the comment, and can be implemented, for example, by various storage devices such as a HDD and a flash memory.

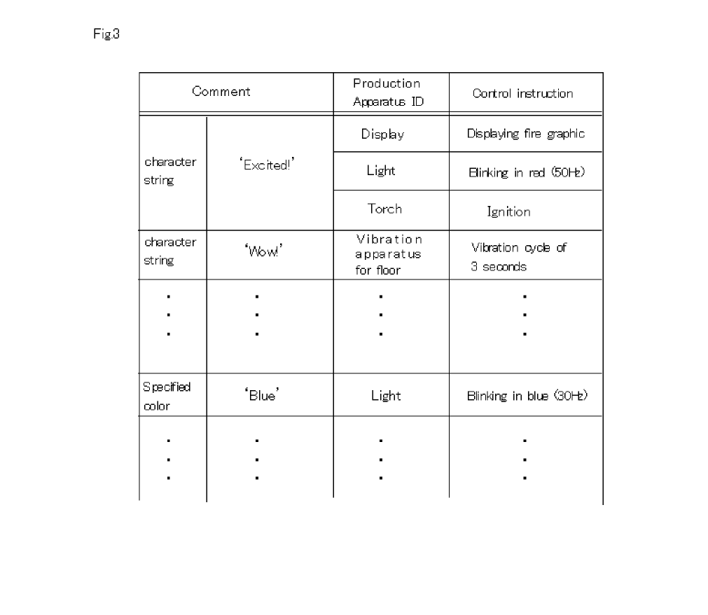

FIG. 3 is a diagram exemplifying a rule for control of production stored in the rule storage. As shown in FIG. 3, in the rule for control of production, for example, character string of (all or a part of) the entered comment and attribute of the comment (specified color etc.) are correlated with the production equipment ID as a target for control, and with the control instruction.

Specifically, the comment including the character string ‘excited’ is correlated with a control instruction for displaying a graphic of flame to the display as a control target, a control instruction for blinking red light to the lighting equipment, or a control instruction for firing a torch to the torch device. Moreover, the comment including ‘applause’ or ‘888888 (expressing claps)’ is correlated with a control instruction for displaying a graphic of standing ovation to the display as the control target, or a control instruction for outputting sound of claps to the sound equipment. Moreover, the comment including ‘Super!’ or ‘Wow’ is correlated with a control instruction for vibration to the floor vibration equipment as the control target.

Moreover, the rule, where it is possible to count the number of the same or synonymous comments, and to vary instruction level (e.g., size of display or color density in graphic, volume of sound, amplitude of vibration, output time thereof, or variation of production display), may be utilized.

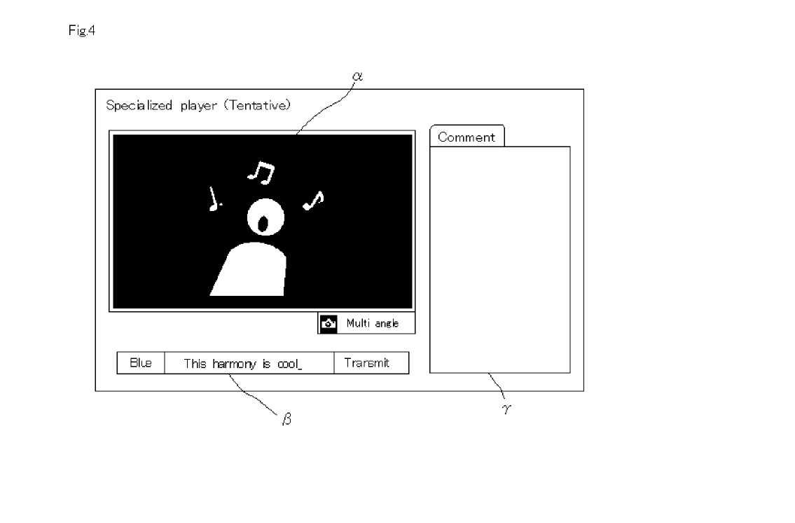

Moreover, as shown in FIG. 4, in addition to the control of production according to the content (character string) of comment and number of comments, the rule, where a control instruction is outputted according to information added to the comment such as a color or size of the comment display, to information of scrolling speed of the display, or to information of the after-mentioned rank of a person who has entered the comment, may be applied. For example, a rule, where if the display color of comment can be designated, an image of the designated color is mainly displayed on the display as the production equipment, or a rule, where the lighting equipment blinks in the designated color, may be applied. Moreover, a rule, where the ‘level’ of the control instruction is varied according to the color or size of the comment display, the scrolling speed of the display, or to the rank of the person who has entered the comment, may be applied.

Moreover, requirements for outputting the control instruction as the rule for controlling production may be correlated. For example, when number or proportion of entered synonymous comments, or number or proportion of comments with the same display color regardless of the content is equal to or more than a predetermined value or proportion, the corresponding control (e.g., the display of image mainly with the designated color, the blinking of the light in the designated color, or blinking of the after-mentioned concert light in the designated color) is executed. Moreover, a rule, where control corresponding to a comment randomly selected from the entered comments is executed, may be applied. Moreover, a rule, where a user's rank is determined on the basis of the user ID included in the comment and a user registration table, which has been preliminarily stored, thereby executing control corresponding to the user of high rank on a priority basis, may be applied.

Moreover, a rule, where it is determined whether comment is used for the production control depending on charging, may be applied. Specifically, a flag indicating a settlement may be included in the comment entered by the user, who has settled the payment (or has made a contract) upon the entry of comment or by pay in advance or in arrears, and the control of production is executed only for the comment including the flag of settlement. Note that, comment without the flag of settlement may be used only for display on the after-mentioned display.

Moreover, for example, on the basis of a combination of a plurality of comments such as ‘guitar on the right side is cool’ and ‘excited’, a control instruction corresponding to the comment ‘excited’ only to the production equipment on the right side of the stage may be executed.

By storing the above various rules for control of production, the subsystem for controlling production can carry out various productions according to the comments.

The ‘comment receiver’ (0204) has a function of receiving the comment transmitted from the user terminal, and can be implemented, for example, by a CPU, a main memory, a communication circuit, and a program for receiving comment. The comment receiver may receive the comment directly from the user terminal (through a transfer unit only for transferring).

Moreover, the comment transferred from another apparatus for processing the comment such as a management server for comment, which processes display of the comment on the display, may be indirectly received. Note that the management server for comment is the same as a server in the conventional distribution system for movie with comment, which collects comments for the distributed movie from a plurality of user terminals, appropriately determines display positions and display speeds of the comments, and redistributes the distributed movie with the comments, so that a description thereof is omitted.

The ‘production controller’ (0205) has a function of controlling the production equipment for the live stage on a basis of the received comment and the stored rule for control of production, and can be implemented, for example, by a CPU, a main memory, and a program for control of production. Moreover, when controlling the display in the hall with stage as the production equipment, this production controller may further comprise a ‘stage display control section’ for controlling the display in the hall (not shown in the figure).

Specifically, when the rule for controlling production defines the control instruction according to the content of the comment, the production controller executes a search of comment row in a table of the rule for controlling production of FIG. 3 using all or a part of the character string of the received comment as a key. Moreover, before the search, when the comment is a sentence etc, it is possible to carry out a morphological analysis on the comment, and to break down the comment by a unit of word class, thereby executing the search with respect to each word class such as noun, verb, adjective, adjective verb, and exclamation.

Subsequently, a control instruction and a production equipment ID as a control target, which are correlated with the field founded by the search, are specified, thereby outputting the control instruction to the specified production equipment.

Moreover, when the rule for controlling production defines the control instruction according to the designated display color of the comment, not to the content of the comment, for example, the information of designated color added as the attribute information of the comment. Subsequently, when production equipment as a control target is the display, an instruction to draw a graphic using the designated color as a main color may be generated and outputted. When production equipment as a control target is LED lighting equipment, an instruction to blink in the designated color may be generated and outputted. Moreover, the production equipment as a destination of the output may be respectively determined according to the color, may be selected in order or randomly, or may be one piece of production equipment.

Moreover, when the rule for controlling production varies the level of instruction (e.g., size of graphic image or color density) as described above, the information for varying the level may be acquired. For example, separately from the character string etc. of the comment for defining the rule itself, when the character string ‘too dark (red)’ etc. is included in the comment, the control of output of red to the production equipment is executed, such that the color value is designated to be ‘dark’ red or ‘light’ red.

Moreover, it is possible to vary the level of instruction according to the information added to the comment such as the size of comment display or scrolling speed, or the information of the rank of the person who has entered the comment. The ‘rank of the person who has entered the comment’ is an index value indicating contribution or priority of the user for the system, which is determined on the basis of a predetermined requirement. For example, the index value can be determined by whether the user is a dues-paying member or not, or by duration of registration for service, number of entries of comments, or estimation for the entered comment from other users. In the subsystem for controlling production, a table indicating the rank of the respective users is preliminarily stored, and the rank is specified by using the user ID of the person, who has entered the comment, as the attribute information of the comment. The level of the control instruction may be varied according to the specified rank (e.g., long duration of blinking or wide variation of the color is given for the comment with high rank).

Moreover, it is possible to determine by matching whether a pattern string regarding position such as ‘right’, ‘center’, or ‘left’ is included in the comment, thereby controlling only the production equipment located in the direction, or the production equipment working toward the direction.

Moreover, it is possible to output a part of the received control instructions, and the requirements for the output may be given. For example, it is possible to count the number of the same (or synonymous) comments received within a predetermined time, and to determine whether the control instruction is outputted according to the counted number and to a comparison result with a threshold indicated in the rule. Moreover, it is possible to randomly extract the comment from the entered comments, and to specify the control instruction only for the comment, thereby outputting the instruction. Moreover, it is possible to output the control instruction for the comment with high rank on the priority basis according to the rank of the person, who has entered the comment.

Moreover, it is possible to output the control instruction in combination of a plurality of comments.

According to the above configuration, the subsystem for controlling production can distribute the image of stage, and can control the stage production according to the received comment for the image entered by the user terminal.

(User Terminal)

Subsequently, description of components of the user terminal of FIG. 2 is provided. The user terminal is connected with the subsystem through the network, and as shown in FIG. 2, comprises a ‘live image receiver’ (0211), a ‘live image display unit’ (0212), a ‘comment entry reception unit’ (0213), and a ‘comment transmitter’ (0214).

The ‘live image receiver’ (0211) has a function of receiving the distributed live image, and can be implemented, for example, by a CPU, a main memory, a communication circuit, and a program for receiving live image.

The ‘live image display unit’ (0212) has a function of displaying the received live image, and can be implemented, for example, by a CPU, a main memory, a image processing circuit, a display, and a program for displaying live image. The virtual viewer using the user terminal can view the live image displayed on the display, and can post the comment of impression etc. Specifically, a distribution request for the live image is transmitted from the user terminal to the server for distributing the live image (e.g., the distribution unit of the subsystem for controlling production) through the network. Subsequently, the server returns, for example, a Web page including a window for reproduction of the live image. Subsequently, when receiving the live image data also distributed from the server, the live image is reproduced in the window for reproduction in the Web page, which has been received, and is displayed on the display of the user terminal. Moreover, when an application for reproducing the live image on the user terminal is preliminarily installed, the transmission/reception of the Web page can be omitted.

Note that, the ‘display (of the user terminal)’ configuring the live image display unit, and the after-mentioned ‘display (for comment)’ (0220 of FIG. 2) as a component of the stage production system may be implemented as separate hardware, or may be implemented as the same hardware (having both functions).

The ‘comment entry reception unit’ (0213) has a function of receiving an entry of a comment for the displayed live image, and can be implemented, for example, by a CPU, a main memory, various input devices such as a keyboard, or a remote control, and a program for receiving entry of comment entry including a GUI for entry of comment.

FIG. 4 is a diagram exemplifying comment entry utilizing the GUI for entry of comment. As shown in FIG. 4, on the display, a display frame a for live image, and an entry field β for entry of comment are displayed on the display. For example, in the case of Web page, the entry field is displayed in the same page or in a page of another window. In the case of application, the entry field is displayed in the application or in another or an overlapping window. The virtual viewer posts, for example, the comment ‘this harmony is cool’ in the entry field β using the keyboard etc while viewing the live image displayed on the display frame α.

Note that the ‘entry of a comment for the displayed live image’ is an entry of a comment correlated with the live image ID. Specifically, for example, the comment entered in the GUI for entry of comment correlated with the display frame for the image (e.g., Web page or application) while displaying the live image, and ID of the live image are correlated with each other. Subsequently, any comment, which has been entered and correlated with the ID of the live image in such manner, may be allowed, and the comment is not limited to a comment relevant to the content of the live performance such as an impression of the live image.

Subsequently, the comments thus entered through the user terminals may be displayed in the display frame α overlapping with the live image, or in a comment list field γ, or may be displayed on the display placed on the stage.

The ‘comment transmitter’ (0214) has a function of promptly transmitting the received comment, and can be implemented, for example, by a CPU, a main memory, a communication circuit, and a program for transmitting comment.

Note that the terms ‘promptly transmitting the received comment’ is not limited to an instant transmission triggered by a click of an entry button for a comment, and may be any transmission without undermining a feeling of participation of the virtual viewer. For example, transmission of some entered comments every 10 seconds may be allowed.

Moreover, the transmission destination of the comment is not limited. It is possible to transmit (output) the comment directly to the subsystem for controlling production or the after-mentioned display, or to the management server for comment, collecting and managing the comments from a plurality of user terminals for displaying them on the display.

Moreover, the promptly transmitted comment is displayed on the after-mentioned display, and as described above, is used for the control of the production equipment by the subsystem for controlling production. Therefore, the virtual viewer can view the display of the comment entered by the viewer, and the live image with production controlled by the comment, so that the viewer can get a feel for participation in the live performance in a different way from the real viewer.

(Display)

Finally, descriptions of components of the display of FIG. 2 are provided. The display is for displaying a comment entered through the user terminal, and as shown in FIG. 2, comprises an ‘comment acquisition unit’ (0221) and a ‘comment display unit’ (0222).

Note that as to the installation site for the display, any site, where the comment can be displayed in a viewable state for the user of the user terminal, is allowed, and two cases are mainly assumed. Therefore, in a first case, the display is provided as the display of the user terminal, and in a second case, the display is placed in the hall with the stage (or a combination of both cases is possible). Hereinafter, descriptions of the ‘comment acquisition unit’ and the ‘comment display unit’ in the two cases are provided separately.

The ‘comment acquisition unit’ (0221) has a function of acquiring the entered comment through the user terminal, and can be implemented, for example, by a CPU, a main memory, and a program for receiving comment. Specifically, when the installation site of the display is that in the first case, the display is connected with the user terminal, so that the comment may be internally acquired. Moreover, when the management server for comment, which receives comments from a plurality of user terminals, and distributes them to a plurality of user terminals, is provided, it is possible to acquire the comments of the viewer self and others distributed from the management server for comment.

Meanwhile, when the installation site of the display is that in the second case, the comment may be directly received from the user terminal through the network. Moreover, similar to the first case, it is possible to indirectly receive the comment entered through a plurality of the user terminals from the management server for comment separately provided on the network.

Moreover, in the second case, it is assumed that the display is under control of the subsystem for controlling production, so that it is possible to acquire the comment, which the subsystem for controlling production has received for the control of production, and transferred. Moreover, in this case, the subsystem for controlling production may generate image data for displaying the comment string in a predetermined color, size, and animation, and the image data may be acquired as the comment. Moreover, the display receives the comment, and the comment may be transferred to the subsystem for controlling production.

The ‘comment display unit’ (0222) has a function of displaying the acquired comment in a viewable state for a user of the user terminal, and can be implemented, for example, by a CPU, a main memory, a processing circuit for image quality, a display panel, and a program for displaying comment. In the display by the comment display unit, for example, color or size of the comment is varied, or the comment string is moved. Moreover, when the display is configured by arranging a plurality of display screens, it is possible to display the comment moving across the displays. Moreover, when the displays are placed on the stage, and around the spectator's seats, therefore, 360-degree display placed on the sidewall, front wall, and back wall, it is possible to display the comment on the 360-degree display in a circular manner.

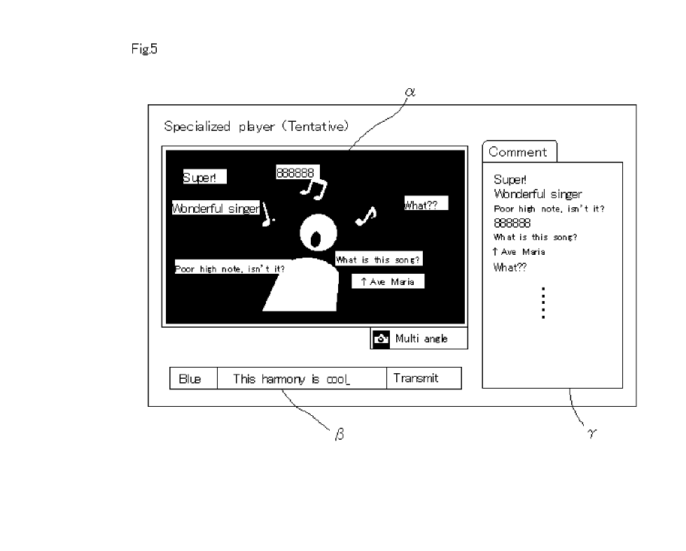

FIG. 5 is a diagram showing an example of displaying comments in the first case of installation site. As shown in FIG. 5, the display is also the live image display unit of the user terminal, and the distributed live image is displayed in the image display frame α. The comment is displayed by overlapping with the image, or listed in the comment list field γ. Moreover, the comment to be displayed here includes not only the comment of the viewer self but also comments, which has been entered from other user terminals, and collected by the management server for comment.

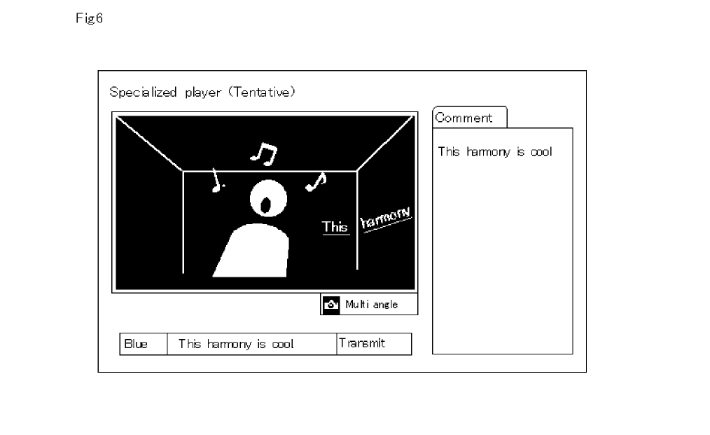

FIG. 6 is a diagram showing another example of displaying comments in the second case of installation site. As shown in FIG. 6, the display is placed on the back wall and side wall on the stage, and the image is taken, such that the live image to be displayed includes at least a part of the display screen. Accordingly, the comment is displayed on the display on the stage, and the comment on the display is included in the live image to be distributed, so that the virtual viewer can view the comment.

Moreover, when the display is placed in the hall with the stage, the display in the hall may be controlled as the production equipment by the production controller of the subsystem for controlling production. In this case, the production is carried out not by ‘displaying the comment’, and but by the blinking of display or varying the color of the entire display other than the comment, in addition to the display of the comment.

As described above, the virtual viewer, who is viewing the live image using the user terminal on the network, can view the display of the comment entered by the viewer, and the live image with production controlled by the comment, so that the viewer can get a feel for participation in the live performance in a different way from the real viewer.

<Hardware Configuration of First Embodiment>

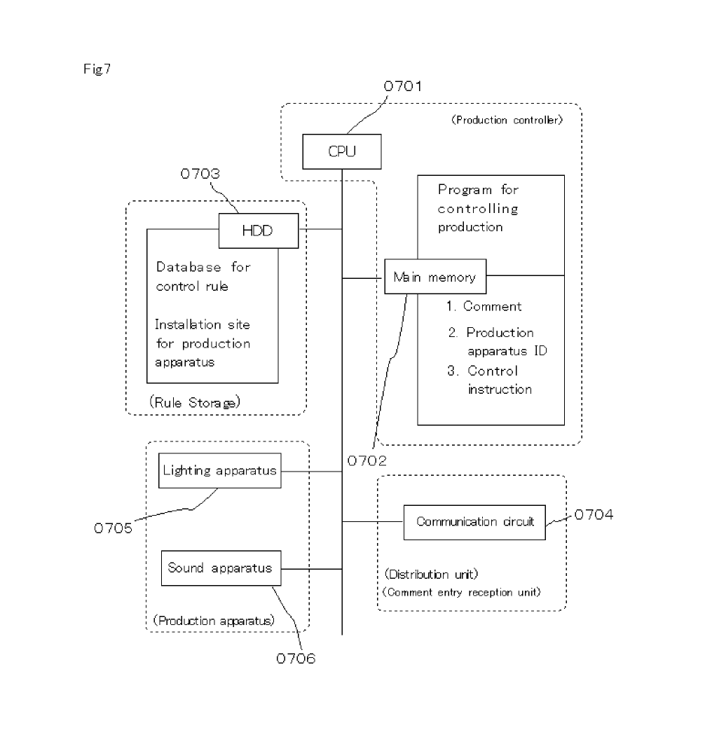

FIGS. 7 to 9 are diagrams exemplifying a hardware configuration for implementing the above respective components in the subsystem for controlling production, the user terminal, and the display. Hereinafter, descriptions of operations of the respective hardware components in the processing of controlling production of the stage production system of the first embodiment will be provided with reference to Figs.

(Subsystem for Controlling Production)

As shown in FIG. 7, the subsystem for controlling production is provided with a ‘CPU’ (0701), and a ‘main memory’ (0702), thereby implementing the production controller, and executing various calculations for other configurations. Moreover, a ‘HDD’ (0703) as a rule storage and a ‘communication circuit’ (0704) as a distribution unit and a comment reception unit, a ‘lighting device’ (0705) and a ‘sound device’ (0706), which are production devices, are provided. These components are mutually connected through the data communication path of ‘system bus’ or ‘LAN (Local Area Network) in a hall’, thereby carrying out transmission/reception and processing of the information.

Moreover, the programs are developed in the ‘main memory’, and the ‘CPU’ refers to the program and executes the various calculations. Moreover, a plurality of addresses are assigned to the main memory and the ‘HDD’, and in the calculation by the ‘CPU’, address specification and access to the stored data are carried out, thereby executing the calculation by utilizing the data.

For example, a band performs on a stage in a site of an open-air music festival, and the performance is shot and distributed in real time to a user terminal of the virtual viewer in remote location through the network. The comment for the distributed live image entered through the user terminal is collected by the management server for comment, and is transmitted to the subsystem for controlling production.

In the subsystem for controlling production, a comment such as ‘absolutely excited!’ is received by the ‘communication circuit’, and the comment is stored in the ‘main memory’. Subsequently, the program for controlling production is interpreted, and according to the interpretation, the ‘CPU’ executes calculation, so that, for example, a morphological analysis on the comment is executed, thereby specifying character string of noun, verb, adjective, adjective verb, and exclamation, excluding particle, auxiliary verb, and conjunction. Subsequently, by utilizing the specified character string as a key, a search of the table of the rule for controlling production of FIG. 3, stored in the ‘HDD’, is executed, and the ID of the production equipment as a target for the control of production, correlated with the field of the string, and the control instruction, for example, the ID of the lighting equipment and the control instruction of blinking in red, are stored in the ‘main memory’.

Subsequently, the control instruction (e.g., the control instruction of blinking in red) is outputted to the production equipment (e.g., the lighting equipment), thereby executing the control in accordance with the control instruction. For example, the lighting equipment blinks in red.

Subsequently, as described in the description of the production controller, for example, the ‘CPU’ counts the number of the synonymous comments with reference to a dictionary of synonymous stored in the ‘HDD’, and may determine whether the control of production is executed according to the comparison result with the threshold indicated in the rule for control of production. Moreover, it is possible to acquire the attribute information added to the comment such as the color or size of the comment display, the scrolling speed of the display, or to the rank of the person who has entered the comment, to store the information in the ‘main memory’, and to execute a search of the table stored in the ‘HDD’ using the information as a key, thereby specifying the production equipment ID and the control instruction. Moreover, according to the value of the information, the ‘CPU’ may execute calculation for acquiring the ‘level’ of the control instruction (volume of sound or control time).

Moreover, the information of installation site of the production equipment is stored in the ‘HDD’, and when the comment includes the string ‘right’, the ‘CPU’ calculates based on the information, such that the ID of the production equipment in the right side of the stage is acquired, and the ID is set as a transmission destination of the control instruction.

Moreover, when the subsystem for controlling production is directly connected with the after-mentioned display through a display output line, the ‘CPU’ interprets a program for displaying comment (not shown in figure), and may generate image data for displaying the comment string in a predetermined color, size, and animation, and the image data may be outputted to the display.

(User Terminal)

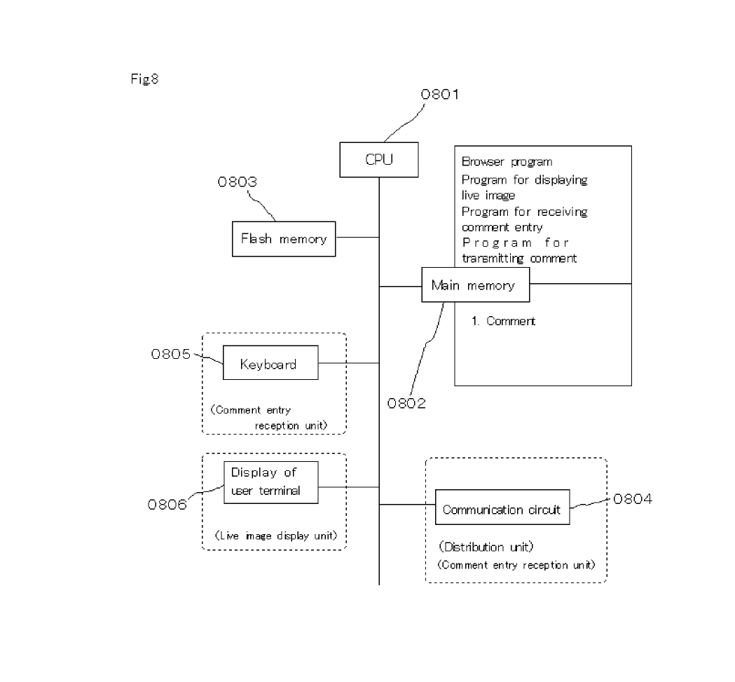

FIG. 8 is a diagram exemplifying a hardware configuration of the user terminal. As shown in FIG. 8, the user terminal comprises a ‘CPU’ (0801) for executing various calculations, and a ‘main memory’ (0802). Moreover, the user terminal comprises a ‘flash memory’ (0803) for storing various data, a ‘communication circuit’ (0804) as the live image receiver and the comment transmitter, a ‘keyboard’ (0805) as the comment reception unit, and a ‘display of user terminal’ (0806) as the live image display unit.

When the user who wishes to view the live image of the stage inputs a predetermined URL into browser, the ‘CPU’ executes access to the subsystem for controlling production indicated by the URL according to the interpretation result of a browser program, and transmits a HTTP request from the ‘communication circuit’. Subsequently, Web page data for viewing the distributed live image (including the program for displaying live image and program for receiving comment) is received as a response from the subsystem for controlling production, and the ‘CPU’ executes display of the Web page data for viewing on the ‘display of user terminal’ according to the interpretation result by a browser program. Simultaneously, the ‘CPU’ executes interpretation of the program for displaying live image included in the Web page data for viewing, and according to the interpretation result, thereby reproducing and displaying the streaming data of the distributed live image, received by the ‘communication circuit’ as a response from the subsystem for controlling production, in the image display frame of the Web page data for viewing.

Moreover, the comment entry field for receiving the entry of comment for the distributed live image is provided in the Web page data for viewing, and the ‘CPU’ executes an interpretation of the program for receiving entry of comment, thereby waiting for the entry of comment into the comment entry field. When the comment is entered in the comment entry field through the ‘keyboard’, and a transmission button is clicked, the ‘CPU’ executes an interpretation of the program for transmitting comment, thereby transmitting the comment from the ‘communication circuit’ through the network. Note that the transmission destination of the comment may be the subsystem for controlling production as a transmission source of the Web page data for viewing and the distributed live image, or may be, for example, the ‘management server for comment’ (not shown in figure) designated by the program for transmitting comment.

Moreover, when the ‘display’ is configured as the same component as the ‘display of user terminal’, it is possible to receive the comment from the user terminal of the viewer self and others by the ‘communication circuit’, and the ‘CPU’ executes calculation, such that the comment is displayed overlapping with the distributed live image (display overlapping the layers for comment), or displayed in the comment list of the Web page data for viewing.

Moreover, separately from the above display processing of the comment, the transmitted comment is received by the subsystem for controlling production as shown in FIG. 7, and is utilized for the control of production for the production equipment. Subsequently, the distributed live image including the scene of the stage with the controlled production is displayed on the ‘display of user terminal’.

(Display)

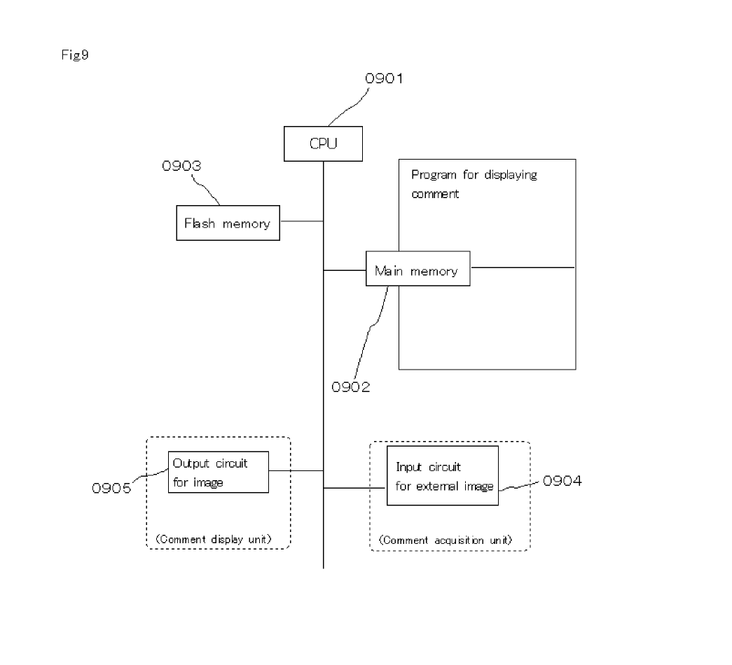

FIG. 9 is a diagram exemplifying a hardware configuration of a display. As shown in FIG. 9, the display comprises a ‘CPU’ (0901) for executing various calculations, and a ‘main memory’ (0902). Moreover, the display comprises a ‘flash memory’ (0903) for storing various data, and an ‘input circuit for external image’ (0904) as the comment reception unit. Moreover, the display comprises an ‘output circuit for image’ (0905) as the comment display unit.

When the display is placed in the hall with the stage, the image data for displaying the comment, received and outputted by the subsystem for controlling production, is received by the ‘input circuit for external image’, and the image data is developed on a VRAM in the ‘input circuit for external image’. Moreover, it is possible to receive the comment, transmitted directly from the user terminal, or indirectly from the management server for comment (not shown in figure) through the Internet, by the ‘communication circuit’, to generate image data for viewing on the basis of the comment, and to develop the image data on the VRAM in the ‘input circuit for external image’.

Moreover, when the ‘display’ is configured as the same component as the ‘display of user terminal’, it is possible to indirectly receive the comment of the viewer self and others, transmitted from the management server for comment (not shown in figure) through the Internet, by the ‘communication circuit’ (not shown in figure), or to internally acquire the comment entered in the user terminal.

Subsequently, the acquired image data is outputted at a predetermined display position on the display panel (not shown in figure).

Moreover, it is possible to display the moving comment string according to the received image data for display. Moreover, when the display is configured by arranging a plurality of display screens, it is possible to display the comment moving across the displays. Moreover, when the displays are placed on the stage, and around the spectator's seats, therefore, 360-degree display placed on the sidewall, front wall, and back wall, it is possible to display the comment on the 360-degree display in a circular manner.

Moreover, the image data for display may be generated in the display. In this case, the acquired comment is stored in the ‘main memory’, and according to the interpretation result of the program for displaying comment, the ‘CPU’ outputs the comment stored in the ‘main memory’ at a predetermined display position on the display panel (not shown in figure) through the ‘output circuit for image’ while processing, for example, to avoid overlap of a plurality of comments when displaying the moving comment.

Moreover, when the display is placed in the hall with the stage, the image is taken, such that the live image to be displayed includes at least a part of the display screen, thereby displaying the comment in a viewable state for the virtual viewer. Moreover, when the display is configured as the same component as the display of user terminal, a video switcher of the subsystem for controlling production overlaps the comment image data in different layer with the distributed live image to be displayed on the display, thereby displaying the comment in a viewable state for the virtual viewer. Moreover, the user terminal overlaps the distributed live image with the comment image data, and displays them, or the comment is displayed in the comment list near the display frame, thereby displaying the comment in a viewable state for the virtual viewer.

<Processing Flow of First Embodiment>

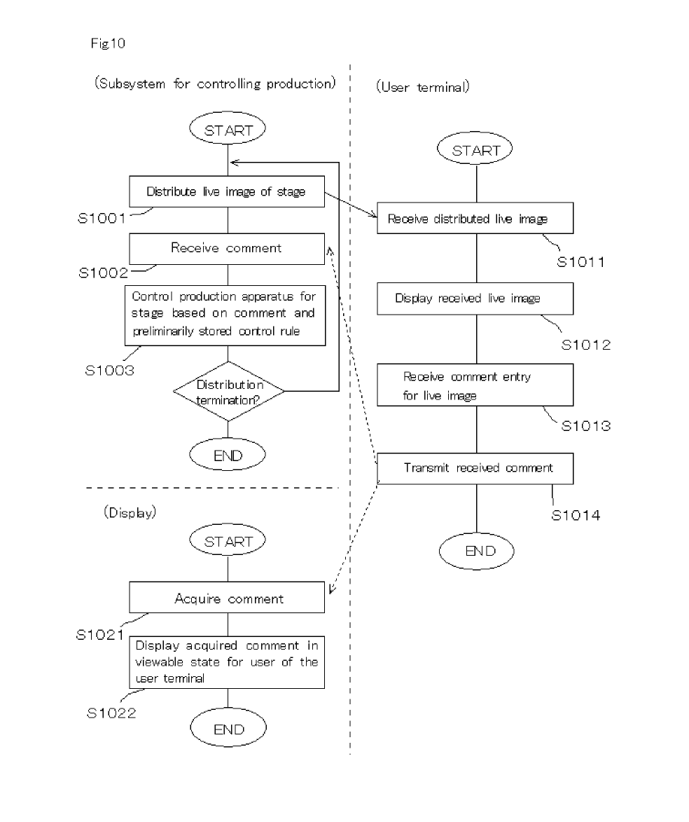

FIG. 10 is a flowchart of the stage production system of the first embodiment. Note that, the following step may be executed by the respective hardware configurations of a computer as above, or may configure a program, which is stored in a medium and is for controlling the computer.

As shown in FIG. 10, at the outset, in response to a distribution request for live image from the user terminal (not shown in figure), the subsystem for controlling production distributes the live image of the stage to the user terminal (a step S1001).

Subsequently, the user terminal receives the distributed live image (a step S1011), and displays the received live image (a step S1012). Moreover, the comment entry field correlated with the display of the live image is displayed, and the entry of comment for the displayed live image is received (a step S1013). When receiving the entry of comment, the comment is promptly transmitted to the subsystem for controlling production or the management server for comment (not shown in figure) (a step S1014).

The subsystem for controlling production directly receives the comment transmitted from the user terminal, or indirectly receives the comment from the management server for comment (not shown in figure) (a step S1002), and executes an analysis on the content (string) of the comment, counting the number of synonymous comments, or various processes for other control of production, thereby controlling the production equipment of the live stage on the basis of the received comment and the stored rule for controlling production (a step S1003). The live image of the stage with the production controlled by the production equipments is constantly distributed to the user terminal to the end of the distribution.

The display acquires the comment entered through the user terminal from the subsystem for controlling production, the user terminal, or the management server for comment (not shown in figure) (a step S1021), and displays the acquired comment in a viewable state for the user of the user terminal (a step S1022)

<Effects of First Embodiment>

According to the stage production system of the first embodiment, even the virtual viewer of the stage can view the distributed live image of the stage including display of the comment entered by the viewer utilizing the user terminal, and can control the production equipments on the stage by the comment, so that the viewer can get a feel for participation in the performance on the real stage in a different way from the viewer of the real stage.

<Other Configuration>

Moreover, according to the stage production system of the first embodiment, it is possible to control a portable production device, which is distributed to the real viewer (audience who actually watches the stage), and which the real viewer wears or holds, in addition to the control of the fixed production equipments in the hall including the stage.

Specifically, the production controller of the subsystem for controlling production may comprise a ‘control section for production device of viewer’, controlling a production device distributed to a viewer in the hall with the stage as the production equipment.

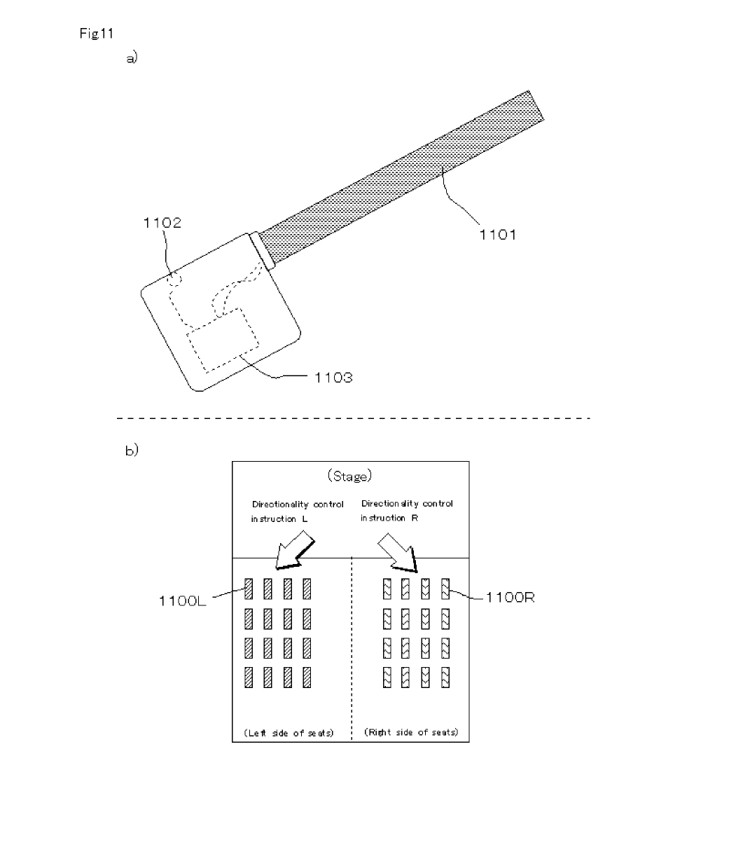

FIG. 11(a) is an illustration of the production equipment to be distributed. As shown in FIG. 11(a), an example of the equipment includes an electronic light stick as an imitation of a chemical light stick, which an audience holds in hands in general concert etc. This electronic light stick comprises LED, light guiding plate, and light reflector etc. (1001), wireless communication circuit (1102), and micro computer for control (1103), and according to the control instruction transmitted via wireless transmission from the production controller of the subsystem for controlling production in response to the comment, the micro computer for control executes LED blinking in various patterns.

Specifically, when the comment string (content) is ‘excited’ as described above, this light stick blinks in red, or when the designated comment display color is ‘blue’ as described above, this light stick blinks in blue. Moreover, this control may be executed only by the comment including the flag indicating settlement, or the control may be executed, such that the blinking speed varies according to the rank of the person who has entered the comment.

As shown in FIG. 11(b), by utilizing, for example, directional infrared communication, it is possible to respectively output directionality control instruction L or R to the production equipment in the left side of the spectator's seats facing to the stage (1100L) or to the production equipment in the right side of the spectator's seats facing to the stage (1100R) in response to the comment

Moreover, this production equipment has a sound output function configured by an internal sound source, sound decoder, and speaker (not shown in figure) in addition to the production using light, and may reproduce and output sound data received from the internal sound source, or externally received sound data.

As described above, it is possible to control the production equipment held by the real viewer according to the comment entered by the virtual viewer, the sense of unity between the real and virtual viewers is enhanced through the stage production.

### Second Embodiment

### Outline of Second Embodiment

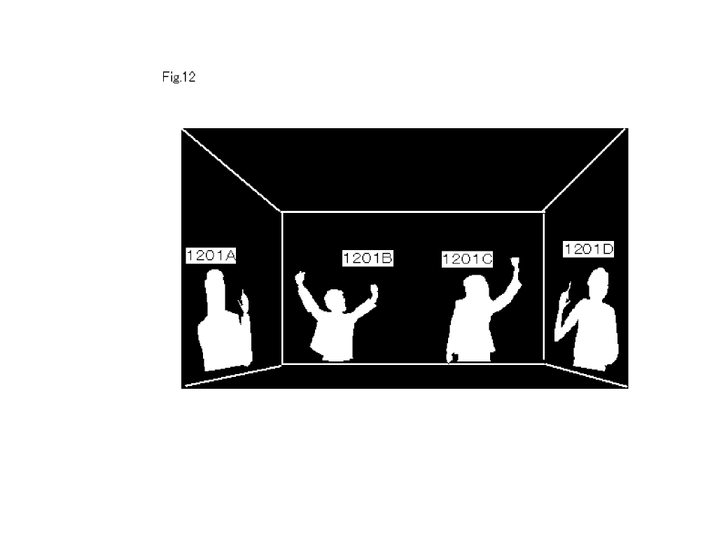

A second embodiment is on the basis of the stage production system, where the display is placed in the hall with the stage, and functions as the production equipment controlled by the production controller, and as shown in FIG. 12, an avatar image (avatar images 1201A-D) of the virtual viewer is displayed on the displays on the side wall and back wall on the stage.

Thus, the avatar image of the virtual viewer, who does not stay at the spectator's seat, is displayed on the displays on the stage, and for example, the avatar dances or jumps in response to the virtual viewer's comment, so that the viewer can get a feel for participation in the performance on the stage.

<Functional Configuration of Second Embodiment>

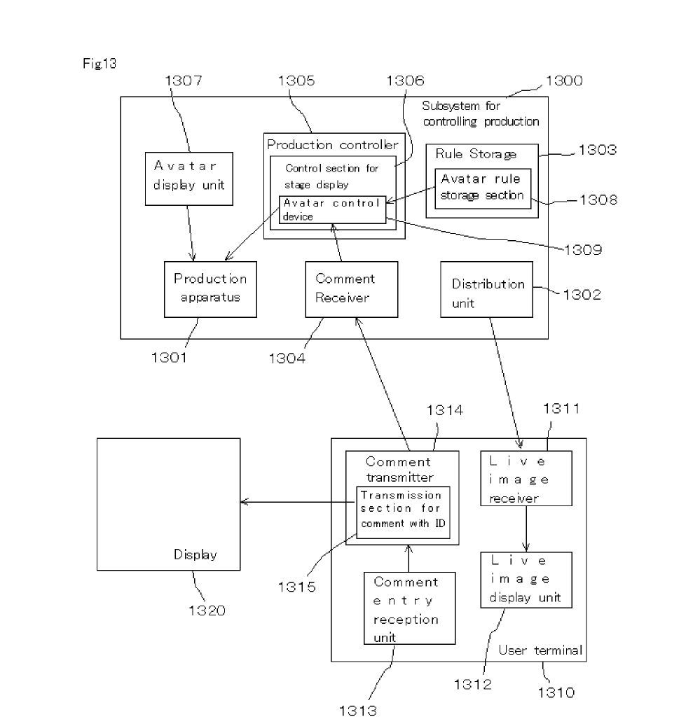

FIG. 13 is a functional block diagram of the stage production system of the second embodiment. As shown in FIG. 13, a stage production system of the second embodiment comprises a ‘subsystem for controlling production’ (1300), a ‘user terminal’ (1310), and a ‘display’ (1320). Note that the components of the display are basically not different from that of the above embodiment, so that figure thereof is not shown.

On the basis of the above embodiment, the subsystem for controlling production comprises a ‘production equipment (including a display)’ (1301), a ‘distribution unit’ (1302), a ‘rule storage’ (1303), a ‘comment receiver’ (1304), and a ‘production controller’ (1305). The ‘production controller’ further comprises a ‘live image receiver’ (1311), a ‘live image display unit’ (1312), a ‘comment entry reception unit’ (1313), and a ‘comment transmitter’ (1314).

Note that the above components are the same as those of the first embodiment, so that descriptions are omitted.

In an aspect of the second embodiment, the comment transmitter of the user terminal further comprises a ‘transmission section for comment with ID’ (1315), the subsystem for controlling production further comprises a ‘display unit for avatar’ (1307), the rule storage further comprises a ‘avatar rule storage section’ (1308), and the stage display control section further comprises a ‘production device for avatar’ (1309).

(User Terminal)

The ‘transmission section for comment with ID’ (1315) has a function of transmitting the comment correlated with a user ID and/or a terminal ID, and can be implemented, for example, by a CPU, a main memory, and a program for transmitting comment with ID.

Specifically, for example, the user makes a registration at the start of receiving service by the stage production system of the second embodiment, and the user sets the user ID arbitrarily or sets an automatically generated ID. After that, the user ID is acquired as login information upon receiving service, and the user ID may be correlated with the comment to be transmitted. In the case of the terminal ID, the terminal ID, arbitrarily set by the user, may be used in similar manner, or the terminal ID such as a product number or a MAC address, which the user terminal preliminarily stores for uniquely identifying the device, is automatically acquired, and may be correlated with the comment.

Thus, the comment includes the user ID or terminal ID, so that it is possible to control production of the avatar according to the comment with respect to each virtual viewer.

(Subsystem for Controlling Production)

The ‘avatar display unit’ (1307) has a function of displaying an avatar on the display in the hall with stage on a basis of the ID, and can be implemented, for example, by a CPU, a main memory, a image processing circuit, and a program for displaying avatar.

In the display of avatar on the basis of the ID, for example, a table for avatar, where the user ID (or terminal ID) and the avatar image of the user are correlated, is stored in the subsystem for controlling production, and the table for avatar is searched by utilizing the ID acquired upon the login by the user as a key, thereby displaying the specified avatar.

Note that the ‘avatar’ is an image of virtual self, and any avatar, which can be perceived by the user, is utilized, and the content of the display image is not limited. Basically, the avatar is a character image generated by using a picture of the user's face, or a combination of preliminarily provided 3D texture images such as a face part and a cloth part. Moreover, for example, an image of user's dog or a favorite flower may be used for the avatar.

Moreover, the avatar of the second embodiment is correlated with the user ID, so that the avatar can be controlled in response to the comment from the user identified by the user ID.

The ‘an avatar rule storage section’ (1308) has a function of storing a rule for control of production for the avatar, and can be implemented, for example, by various storage such as a HDD, or a flash memory.

The avatar rule is characterized in that the control of production for the avatar, identified by the ID with respect to each user or terminal, according to the comment is distinctively executed based on the ID correlated with the comment (i.e., the virtual viewer controls the production of his avatar by his comment), and in that the content of the production corresponds to the control of displaying the avatar (e.g., animation display of the avatar, or variation of color or size of display).

The ‘avatar production device’ (1309) has a function of producing the avatar displayed on the display on a basis of the received comment and ID, and on the stored rule for control of production for avatar, and can be implemented, for example, by a CPU, a main memory, a image processing circuit, and a program for producing avatar.

Specifically, for example, according to the comment ‘sound of claps’ or the comment ‘encore’, inputted by the user α, an animation showing that hands of the avatar of the user a moves like clapping is displayed. Moreover, according to the comment ‘excited’, inputted by the user β, an animation showing that head of the avatar of the user β does head banging, or that face of the avatar glows red is displayed.

<Processing Flow of Second Embodiment>

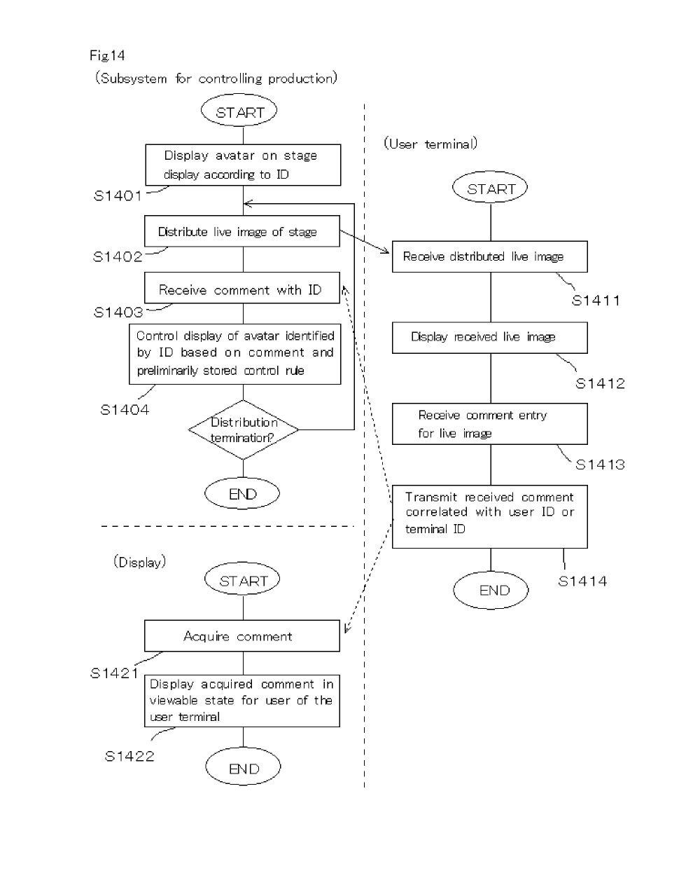

FIG. 14 is a flowchart of the stage production system of the second embodiment. Note that, the following step may be executed by the respective hardware configurations of a computer as above, or may configure a program, which is stored in a medium and is for controlling the computer.

As shown in FIG. 14, at the outset, in response to a distribution request for live image from the user terminal (not shown in figure), for example, according to the user ID or the terminal ID, acquired upon login for the processing, the avatar image of the user is displayed on the display placed on the stage etc (a step S1401). Subsequently, in response to a distribution request for live image, the subsystem for controlling production distributes the live image of the stage to the user terminal (a step S1402). Subsequently, the user terminal receives the distributed live image (a step S1411), and displays the received live image (a step S1412). Moreover, the comment entry field correlated with the display of the live image is displayed, and the entry of comment for the displayed live image is received (a step S1413). When receiving the entry of comment, the comment, correlated with the user ID or terminal ID, is promptly transmitted to the subsystem for controlling production or the management server for comment (not shown in figure) (a step S1414).

The subsystem for controlling production directly receives the comment with ID transmitted from the user terminal, or indirectly receives the comment from the management server for comment (not shown in figure) (a step S1402), and executes an analysis on the content (string) of the comment, counting the number of synonymous comments, or various processes for other control of production, thereby controlling display of the avatar identified by the ID added to the comment on the basis of the received comment and the stored rule for controlling production (a step S1403). The live image of the stage with the production controlled by the production equipment is constantly distributed to the user terminal to the end of the distribution.

The display acquires the comment entered through the user terminal from the subsystem for controlling production, the user terminal, or the management server for comment (not shown in figure) (a step S1421), and displays the acquired comment in a viewable state for the user of the user terminal (a step S1422)

<Effects of Second Embodiment>

According to the stage production system of the second embodiment, the avatar image of the virtual viewer, who does not stay at the spectator's seat, is displayed on the displays on the stage, and for example, the avatar dances or jumps in response to the virtual viewer's comment, so that the viewer can get a feel for participation in the performance on the stage.

### Third Embodiment

### Outline of Third Embodiment

In a stage production system of a third embodiment, similar to the second embodiment, an avatar displayed on a display of a stage is controlled, thereby executing stage production. A difference with the second embodiment is that the display control of the avatar is executed according to comments from a plurality of unspecified users, not to the user, whose ID is correlated with the avatar. Therefore, in the stage production system of a third embodiment, it is possible to easily

<Functional Configuration of Third Embodiment>

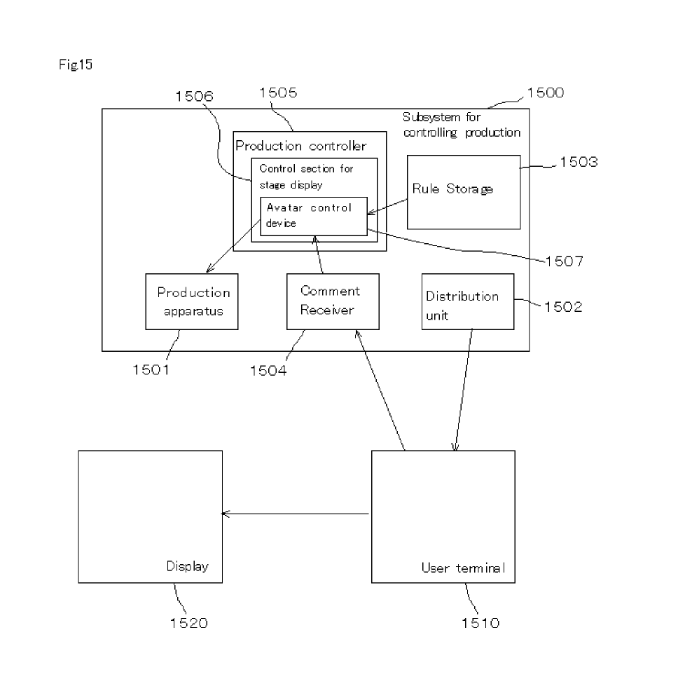

FIG. 15 is a functional block diagram of the stage production system of the third embodiment. As shown in FIG. 15, a stage production system of the third embodiment comprises a ‘subsystem for controlling production’ (1500), a ‘user terminal’ (1510), and a ‘display’ (1520). Note that the components of the user terminal and the display are basically not different from that of the above embodiment, so that figure thereof is not shown.

The subsystem for controlling production comprises a ‘production equipment (including a display)’ (1501), a ‘distribution unit’ (1502), a ‘rule storage’ (1503), a ‘comment receiver’ (1504), and a ‘production controller’ (1505). The ‘production controller’ further comprises a ‘stage display control section’ (1506). These components are described in the above embodiment, so that a description thereof is omitted. Moreover, in the third embodiment, the ‘stage display control section’ (1506) further comprises an ‘avatar control device’ (1507)

The ‘avatar control device’ (1507) has a function of controlling an action of an avatar to be displayed on the display placed on the stage, and can be implemented, for example, by a CPU, a main memory, an image processing circuit, and a program for controlling avatar. The production controller and the stage display control section are for controlling the production of the stage display utilizing the comment and the rule for control of production, and the avatar control device controls the action of the avatar displayed on the display. For example, on the basis of the comment and the rule for control of production, various animation displays are executed.

The avatar, which is displayed on the display, and controlled, is not necessarily to be correlated with a specific user by the user ID as the avatar of the second embodiment (it can be correlated with the ID, but the ID correlated with the avatar is not used). Note that the image of the avatar is not limited, and any image, which is not correlated with the user ID, and is preliminarily determined or randomly selected, may be used as the avatar, and the image is not limited to a human-shaped image.

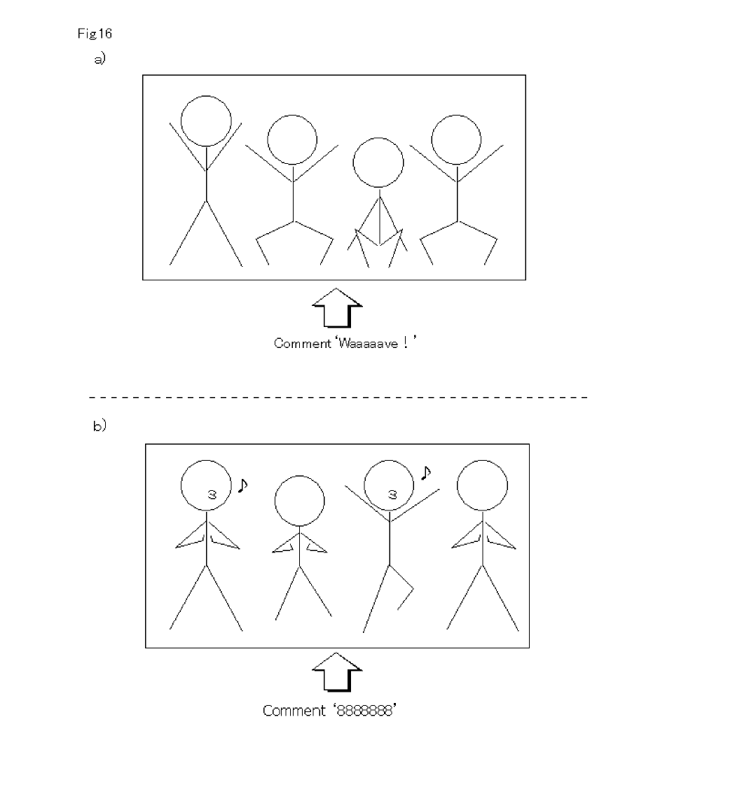

FIG. 16 is a conceptual diagram exemplifying an action control of an avatar by the avatar control device. As shown in FIG. 16(a), on the basis of the rule for control of production corresponding to the comment, which has been randomly selected, or which is from the user with the highest rank, says ‘waaaaave!’, an animation imitating Mexican wave, where a plurality of avatars displayed in a line on the stage display make action of standing up and squatting down from right to left, is displayed.

Moreover, as shown in FIG. 16(b), on the basis of the rule for control of production corresponding to the comment of the largest number of entries, for example, ‘888888’, an animation, where all avatars displayed on the stage display simultaneously clap and whistle, is displayed (or speakers output the sound of claps and whistles), thereby showing a scene, where the audience celebrates the stage performance and is excited.

Thus, according to the stage production system of the third embodiment, different from the production by controlling the avatar correlated with the user ID with respect to each comment, it is possible to simultaneously control actions of a plurality of avatars using some comments of a plurality of comments, thereby executing a production with a sense of unity such as the Mexican wave or a human letters using boards.

Moreover, in the stage production system of the third embodiment, in order to execute production by the action of the avatar at appropriate timing, for example, according to the progress of the stage event, it is possible to receive an instruction of initiating action separately from the comment from the user. Specifically, in the stage production system of the third embodiment, the production controller may further comprise a reception section for initiating action (not shown in figure). The ‘reception section for initiating action’ has a function of initiating the action of the avatar to be displayed on the display placed on the stage, and can be implemented, for example, by a CPU, a main memory, an input device, and a program for initiating action of avatar.

Specifically, for example, a ‘button for initiating action’ is provided on the console panel in a control room located on the position with a full view of the stage. When the magic show on the stage approaches the end, a large number of comments ‘888888’ are entered from the users. However, in the stage production system of the third embodiment, the control of action of the avatar (e.g., display of animation showing claps) according to the comments is not executed at this timing.

Subsequently, the production staff checks a timetable of the stage, and presses the button when the final magic is exhibited at the climax. Then, an animation of claps by the avatars according to the comments ‘888888’, which have been entered, is displayed, thereby boosting the mood of the magic show.

Note that the reception section for initiating action is not limited to the above example, and for example, the instruction of initiating action may be automatically inputted by a computer, or the section may be provided to the user terminal of the viewer or the user who enters a comment, and it is possible to determine the timing of the action control of the avatar by the action initiating operation received from a predetermined one user (e.g., the user who has been randomly selected, or the user with high rank). Moreover, since it is preferable that the display of the comment and the action of the avatar according to the comment are simultaneously executed, the received instruction of initiating action may also act as an instruction of initiating display of comment.

<Processing Flow of Third Embodiment>

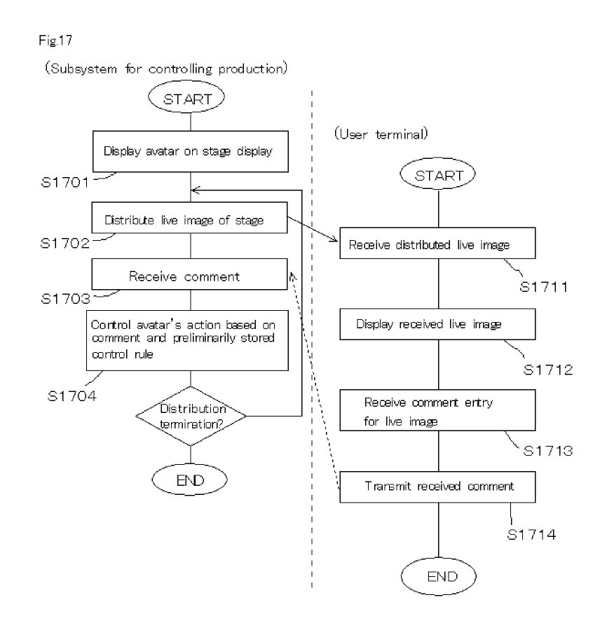

FIG. 17 is a flowchart of the stage production system of the third embodiment. Note that, the following step may be executed by the respective hardware configurations of a computer as above, or may configure a program, which is stored in a medium and is for controlling the computer.

As shown in FIG. 17, at the outset, the avatar is displayed on the stage display (a step S1701). Subsequently, in response to a distribution request for live image, the subsystem for controlling production distributes the live image of the stage to the user terminal (a step S1702). Subsequently, the user terminal receives the distributed live image (a step S1711), displays the received live image (a step S1712), and the entry of comment for the displayed live image is received (a step S1713). Subsequently, the user terminal promptly transmits the comment to the subsystem for controlling production or the management server for comment (not shown in figure) (a step S1714).

The subsystem for controlling production directly receives the comment transmitted from the user terminal, or indirectly receives the comment from the management server for comment (not shown in figure) (a step S1703), and executes an analysis on the content (string) of the comment, counting the number of synonymous comments, or various processes for other control of production, thereby controlling action of the avatar displayed on the display on the basis of the received comment and the stored rule for controlling production (a step S1704).

<Effects of Third Embodiment>

According to the stage production system of the third embodiment, it is possible to simultaneously control actions of a plurality of avatars using some comments of a plurality of comments, thereby executing a production with a sense of unity such as the Mexican wave or a human letters using boards.

### DESCRIPTION OF REFERENCE NUMERALS

0200 Subsystem for controlling production
0201 Production apparatus
0202 Distribution unit
0203 Rule storage
0204 Comment receiver
0205 Production controller
0210 User terminal
0211 Live image receiver
0212 Live image display unit
0213 Comment entry reception unit
0214 Comment transmitter
0220 Display
0221 Comment acquisition unit
0222 Comment display unit

1. A stage production system, comprising:
a subsystem for controlling production, controlling stage production;
a user terminal, being connected with the subsystem for controlling production through network; and
a display, displaying a comment entered through the user terminal,
wherein the subsystem for controlling production further comprises
a production equipment, producing stage,
a distribution unit, distributing a live image of the stage to the user terminal,
a rule storage, storing a rule for control of production on a basis of the comment,
a comment receiver, receiving the comment transmitted from the user terminal, and
a production controller, controlling the production equipment for the live stage on a basis of the received comment and the stored rule for control of production,
wherein the user terminal further comprises
a live image receiver, receiving the distributed live image,
a live image display unit, displaying the received live image,
a comment entry reception unit, receiving an entry of a comment for the displayed live image, and
a comment transmitter, promptly transmitting the received comment, and
wherein the display further comprises
a comment acquisition unit, acquiring the entered comment through the user terminal, and
a comment display unit, displaying the acquired comment in a viewable state for a user of the user terminal.

2. The stage production system according to claim 1,
wherein the display is placed in a hall with the stage.

3. The stage production system according to claim 2
wherein the production controller of the subsystem for controlling production further comprises a stage display control section, controlling the display as the production equipment in the hall with the stage.

4. The stage production system according to claim 3
wherein the stage display control section further comprises an avatar control device, controlling an action of an avatar to be displayed on the display placed on the stage.

5. The stage production system according to claim 4,
wherein the production controller further comprises a reception section for initiating action, initiating the action of the avatar to be displayed on the display placed on the stage.

6. The stage production system according to claim 3
wherein the comment transmitter of the user terminal further comprises a transmission section for comment with ID, transmitting the comment correlated with a user ID and/or a terminal ID, and
wherein the subsystem for controlling production further comprises an avatar display unit, displaying an avatar on the display in the hall with stage on a basis of the ID,
the rule storage further comprises an avatar rule storage section, storing a rule for control of production for the avatar, and
the stage display control section further comprises an avatar production device, producing the avatar displayed on the display on a basis of the received comment and ID, and on the stored rule for control of production for avatar.

7. The stage production system according to claim 1,
wherein the production controller of the subsystem for controlling production further comprises a control section for production device of viewer, controlling a production device distributed to a viewer in the hall with the stage as the production equipment.

8. A subsystem for controlling production that controls stage production, and is connected with a user terminal through network, the system comprising:
a production equipment, producing stage;
a distribution unit, distributing a live image of the stage to the user terminal;
a rule storage, storing a rule for control of production on a basis of the comment entered through the user terminal;
a comment receiver, receiving the comment entered to the user terminal, and promptly transmitted from the user terminal, in response to the distributed live image
a production controller, controlling the production equipment for the live stage on a basis of the received comment and the stored rule for control of production; and
a comment display unit, displaying the acquired comment in a viewable state for a user of the user terminal.

9. A method for operating a stage production system that comprises a subsystem for controlling production, controlling stage production, a user terminal, being connected with the subsystem for controlling production through network, and a display, displaying a comment entered through the user terminal, the method causing a computer to execute a process, comprising:
in the subsystem for controlling production that includes a production equipment, producing stage, and a rule storage, storing a rule for control of production on a basis of the comment;
distributing a live image of the stage to the user terminal,
receiving the comment transmitted from the user terminal, and
controlling the production equipment for the live stage on a basis of the received comment and the stored rule for control of production,
in the user terminal;
receiving the distributed live image,
displaying the received live image,
receiving the entry of the comment for the displayed live image, and
promptly transmitting the received comment, and
in the display;
acquiring the entered comment through the user terminal, and
displaying the acquired comment in a viewable state for a user of the user terminal.

10. A method for operating a subsystem for controlling production that is connected with a user terminal through network, and comprises a production equipment, producing stage, and a rule storage, storing a rule for control of production on a basis of a comment entered through a user terminal, the method causing a computer to execute a process, comprising:
distributing a live image of the stage to the user terminal;
receiving the comment, entered to the user terminal, and promptly transmitted from the user terminal, in response to the distributed live image;
controlling the production equipment for the live stage on a basis of the received comment and the stored rule for control of production; and
displaying the received comment in a viewable state for a user of the user terminal.

11. A computer-readable storage medium storing a program for causing a computer to execute a process of operating a stage production system that comprises a subsystem for controlling production, controlling stage production, a user terminal, being connected with the subsystem for controlling production through network, and a display, displaying a comment entered through the user terminal, the program comprising:
in the subsystem for controlling production that includes a production equipment, producing stage, and a rule storage, storing a rule for control of production on a basis of the comment;
distributing a live image of the stage to the user terminal,
receiving the comment transmitted from the user terminal, and
controlling the production equipment for the live stage on a basis of the received comment and the stored rule for control of production,
in the user terminal;
receiving the distributed live image,
displaying the received live image,
receiving the entry of the comment for the displayed live image, and
promptly transmitting the received comment, and
in the display;
acquiring the entered comment through the user terminal, and
displaying the acquired comment in a viewable state for a user of the user terminal.

12. A computer-readable storage medium storing a program for causing a computer to execute a process of operating a subsystem for controlling production that is connected with a user terminal through network, and comprises a production equipment, producing stage, and a rule storage, storing a rule for control of production on a basis of a comment entered through a user terminal, the program comprising:
distributing a live image of the stage to the user terminal;
receiving the comment, entered to the user terminal, and promptly transmitted from the user terminal, in response to the distributed live image;
controlling the production equipment for the live stage on a basis of the received comment and the stored rule for control of production; and
displaying the received comment in a viewable state for a user of the user terminal.
